(19) United States
(12) Patent Application Publication
(10) Pub. No.: US 2023/0044581 A1
(43) Pub. Date: Feb. 9, 2023

(54) LEARNING-BASED POWER MODELING OF A PROCESSOR CORE AND SYSTEMS WITH MULTIPLE PROCESSOR CORES

(71) Applicant: Xilinx, Inc., San Jose, CA (US)

(72) Inventors: Tim Tuan, San Jose, CA (US); Seokjoong Kim, San Jose, CA (US); Sai Anirudh Jayanthi, Dallas, TX (US)

(73) Assignee: Xilinx, Inc., San Jose, CA (US)

(21) Appl. No.: 17/394,714

(22) Filed: Aug. 5, 2021

(51) Int. Cl. G06F 30/20; G06F 1/06; G06F 1/28; G06F 12/02

(52) U.S. Cl. CPC G06F 30/20; G06F 1/06; G06F 1/28; G06F 12/023; G06F 2119/12

(57) ABSTRACT

Learning-based power modeling of a processor core includes generating, using computer hardware, pipeline snapshot data specifying a plurality of snapshots for a pipeline of a processor core. Each snapshot specifies a state of the pipeline for a clock cycle in executing a computer program over a plurality of clock cycles. A plurality of estimates of power consumption for the processor core in executing the computer program for the plurality of clock cycles are determined, using an instruction-based power model executed by the computer hardware, a based on the pipeline snapshot data. The plurality of estimates of power consumption are calculated using the instruction-based power model based on the plurality of snapshots over the plurality of clock cycles.

### TECHNICAL FIELD

This disclosure relates to learning-based power modeling of electronic systems such as integrated circuits and, more particularly, to power modeling of a processor core and/or systems including multiple processor cores.

### BACKGROUND

Modern processors capable of executing program code are complex systems in and of themselves. This complexity makes estimating power consumption of a processor a difficult and complex task. There may be thousands of different factors that affect the amount of power consumed by the processor at any given time. Given the difficulty of accounting for such a large number of factors and the even larger number of possible combinations of factors, the typical approach to estimating power consumption of a processor has been to rely on only a small subset of the available factors. While the subset of factors selected may be those that most heavily influence power consumption of the processor, this approach, while practical, often results in erroneous estimates of power consumption for the processor.

### SUMMARY

In an example implementation, a method includes generating, using computer hardware, pipeline snapshot data specifying a plurality of snapshots for a pipeline of a processor core. Each snapshot specifies a state of the pipeline for a clock cycle in executing a computer program over a plurality of clock cycles. The method includes determining, using an instruction-based power model executed by the computer hardware, a plurality of estimates of power consumption for the processor core in executing the computer program for the plurality of clock cycles based on the pipeline snapshot data. The plurality of estimates of power consumption are calculated using the instruction-based power model based on the plurality of snapshots over the plurality of clock cycles.

In another example implementation, a system includes a processor configured to initiate operations. The operations include generating pipeline snapshot data specifying a plurality of snapshots for a pipeline of a processor core representing states of the pipeline in executing a computer program over a plurality of clock cycles. The operations include determining, using an instruction-based power model, a plurality of estimates of power consumption for the processor core in executing the computer program for the plurality of clock cycles based on the pipeline snapshot data. The instruction-based power model specifies power consumption of the processor core for different states of the pipeline corresponding to the plurality of snapshots over the plurality of clock cycles.

In another example implementation, a method includes generating, using computer hardware, pipeline snapshot data specifying a plurality of snapshots for a pipeline of a processor core executing a training computer program over a plurality of clock cycles. The operations include determining a plurality of estimates of power consumption for the processor core for the plurality of clock cycles by performing a gate-level simulation of a circuit design for the processor core based on signal data generated by simulating execution of the training computer program using the circuit design. The operations include generating an instruction-based power model that correlates the plurality of estimates of power consumption of the processor core for the plurality of clock cycles with the plurality of snapshots.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 illustrates an example system for creating an instruction-based power model (IPM) for a processor core.

FIG. 2 illustrates an example method of generating an IPM using the system of FIG. 1.

FIG. 3 illustrates an example system for estimating the power consumption of a processor core in executing a selected computer program using an IPM for the processor core.

FIG. 4 illustrates an example method of generating per-cycle estimates of power consumption for a user computer program executing on the processor core using an IPM.

FIG. 5 illustrates another example method of generating an IPM.

FIG. 6 illustrates another example method of estimating power consumption of a processor core using an IPM.

FIG. 7 illustrates an example of a data processing system for use with the inventive arrangements described herein.

### DETAILED DESCRIPTION

This disclosure relates to learning-based power modeling of electronic systems such as integrated circuits (ICs) and, more particularly, to power modeling of a processor core and/or systems including multiple processor cores. Methods, systems, and computer program products are provided for modeling the power consumption of a processor core. The term “processor core” means a single electronic circuit having a pipelined circuit architecture that is capable of executing program instructions. For example, a “processor core” refers to a single core of a processor, whether the processor includes one core or two or more cores. A multi-core processor includes a plurality of “processor cores.” A processor array formed of many processor circuits or cores (e.g., tens or hundreds of processor circuits) includes many instances of a “processor core.” By modeling the power consumption of a single processor core, the power modeling techniques described within this disclosure may be extended for use with systems having two or more processor cores whether such processor cores are disposed in a same processor (e.g., a packaged IC), included in multiple different processors (e.g., different packaged ICs), included in a same die of an IC, or included across different dies of a multi-die IC.

A pipelined circuit architecture, or “pipeline,” of a processor core is multi-stage circuitry through which instructions of a computer program executed by the processor core flow. Execution of instructions by the processor core is typically subdivided into different sequential stages of the pipeline. The pipeline allows different parts of the instructions to be executed by the processor core in parallel in the respective stages. This means that a larger portion of the processor core remains busy performing some aspect of instruction execution so long as instructions continue to flow through the stages of the pipeline.

In one or more example implementations, power consumption of a processor core is modeled based, at least in part, on the state of the pipeline of the processor core at any given time. The inventive arrangements described herein are directed to the creation and use of an instruction-based power model (IPM) for a processor core. The processor core is capable of executing instructions of a computer program, where the instructions are part of an instruction set (e.g., set of instructions) executable by the processor core. An IPM for the processor core may be created that specifies, e.g., may be used or executed to calculate, an amount of power consumed by the processor core for a given state of the pipeline of the processor core. The IPM is capable of specifying, for each instruction included in the pipeline of the processor core, a contribution of that instruction to the power consumption of the processor core. The contribution of each instruction depends on the particular stage of the pipeline in which the instruction is located as well as the other instructions in other stages of the pipeline. Thus, the contribution of an instruction in the pipeline toward power consumption of the processor core depends on which stage of the pipeline the instruction is located, and which instructions are located in each of the other stages of the pipeline. As the pipeline is sequential in nature, the instructions within the pipeline have a sequence.

As discussed, there may be thousands of different factors that influence the power consumption of the processor core at any given time. Accounting for all known factors of the processor core leads to an exponential growth in the different combinations of factors that must be considered. To avoid dealing with such a large data set, conventional techniques for estimating power consumption of a processor core tend to focus on only a significantly reduced set of the factors considered to be the dominant factors. Unlike conventional techniques, the IPM is capable of taking into account a broad range of factors by accounting for the state of the pipeline of the processor core, in general, on a per clock cycle basis. Once generated, the IPM may be applied to a user computer program intended for execution on the processor core to provide a more accurate estimate of power consumption of the processor core in executing the user computer program.

The IPM may be extended to account for circuitry other than the pipeline of the processor core. Such other circuitry is referred to as non-pipeline components or non-pipeline portions of the processor core. Examples of other circuits that may be accounted for in the IPM include circuitry of the processor core capable of reading and writing a memory (e.g., a direct memory access or “DMA” circuit), circuits capable of conveying data such as switches, and the like.

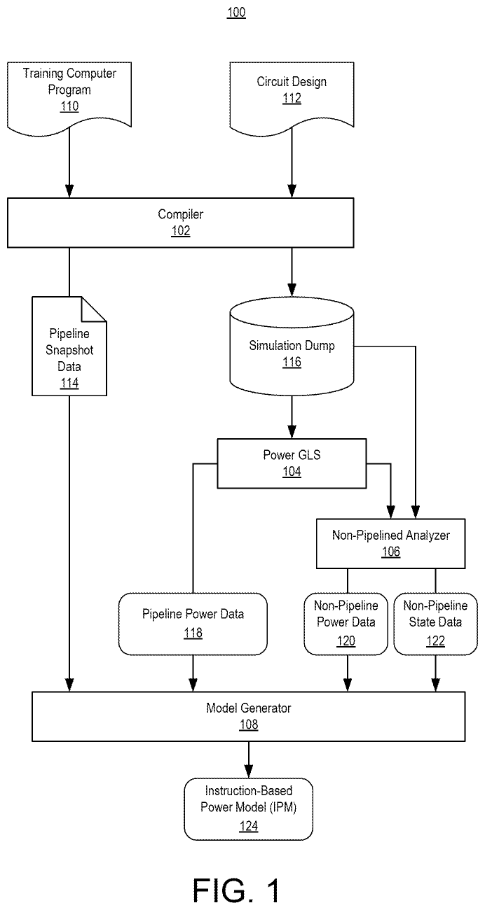

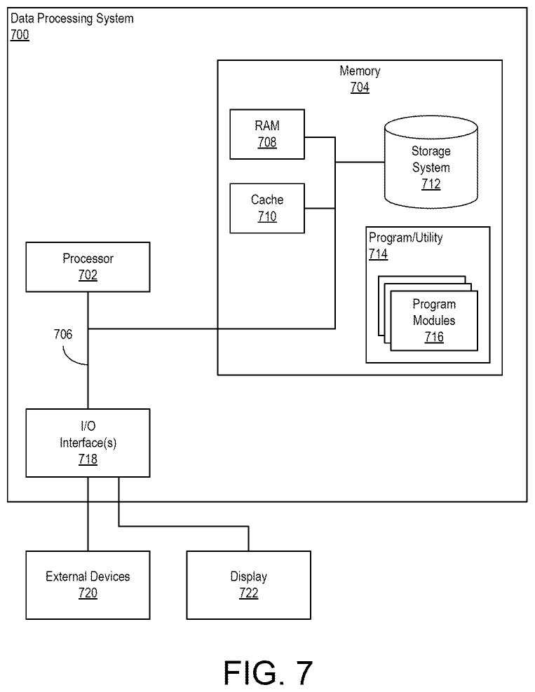

FIG. 1 illustrates an example system 100 for creating an IPM for a processor core. System 100 may be implemented as a combination of hardware and software embodied in a data processing system. For example, system 100 may be implemented as a computer system executing suitable program code. An example of a data processing system in which system 100 may be implemented is described herein in connection with FIG. 7. System 100 illustratively includes a compiler 102, a power Gate-Level Simulator (GLS) 104, a non-pipelined analyzer 106, and a model generator 108.

System 100 is capable of generating an IPM 124 for a particular processor core based on a training computer program 110 and a circuit design 112. Training computer program 110 may be a computer program that is specified in a high-level programming language (HLPL), e.g., as source code. Training computer program 110 may include a variety of different HLPL instructions that, as compiled for execution on the processor core for which IPM 124 is being generated, translate into a variety of instructions of an instruction set of the processor core represented by design 112.

The processor core represented by circuit design 112 is capable of executing a plurality of different instructions referred to herein as an instruction set. The term “instruction set” refers to the particular instructions or code (e.g., tasks such as opcodes) that the processor core is capable of understanding and executing. For purposes of generating IPM 124, training computer program 110 may include a wide variety of HLPL instructions so that the pipeline of the processor core, in executing training computer program 110, is placed in a variety of different states.

As defined herein, the term “high-level programming language” or “HLPL” means a programming language, or set of instructions, used to program a processor core where the instructions have a strong abstraction from the details of the processor core, e.g., machine language. For example, a high-level programming language may automate or hide aspects of operation of the processor core such as memory management. The amount of abstraction typically defines how “high-level” the programming language is. Using a high-level programming language frees the user from dealing with registers, memory addresses, and other low-level features of the processor core upon which the high-level programming language, once compiled, will execute. In this regard, a high-level programming language may include little or no instructions that translate directly, on a one-to-one basis, into a native opcode (e.g., instructions of the instruction set) of the processor core. Examples of high-level programming languages include, but are not limited to, C, C++, SystemC, OpenCL C, scripted languages such as Python, or the like.

Circuit design 112 may be implemented as one or more files specifying the circuit architecture of the particular processor core for which IPM 124 is generated. In an example, circuit design 112 may be specified as a netlist. The netlist may be specified in a hardware description language. Circuit design 112 may include low-level layout information for the circuitry of the processor core. In one or more example implementations, circuit design 112 may specify information including, but not limited to, Resistive-Capacitive (RC) parasitics of the processor core that may be used for purposes of simulating circuit design 112. Such information may be included in circuit design 112 or specified in one or more other files logically linked or otherwise associated with circuit design 112.

As defined herein, the term “hardware description language” or “HDL” is a computer-language that facilitates the documentation, design, and manufacturing of a digital system, such as an IC or in this case a processor core. An HDL is expressed in human readable form and combines program verification techniques with expert system design methodologies. Using an HDL, for example, a user can design and specify an electronic circuit, describe the operation of the circuit, and create tests to verify operation of the circuit. An HDL includes standard, text-based expressions of the spatial and temporal structure and behavior of the electronic system being modeled. HDL syntax and semantics include explicit notations for expressing concurrency. In contrast to most high-level programming languages, an HDL also includes an explicit notion of time, e.g., clocks and/or clock signals, which is a primary attribute of a digital system. For example, an HDL design may describe the behavior of a circuit design as data transfers occur between registers each clock cycle. Examples of HDLs may include, but are not limited to, Verilog and VHDL. HDLs are sometimes referred to as register transfer level (RTL) descriptions of circuit designs and/or digital systems. Both Verilog and VHDL support the ability to specify attributes on modules in their native syntax.

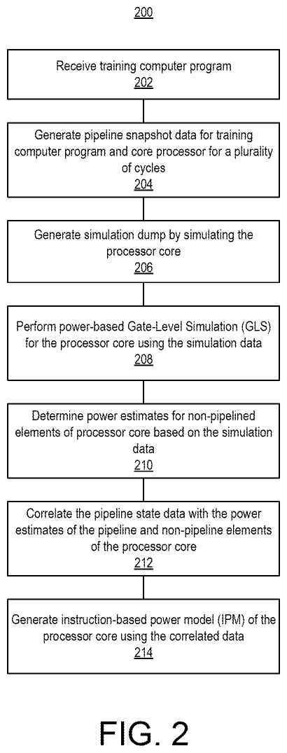

FIG. 2 illustrates an example method 200 of generating IPM 124 using system 100 of FIG. 1. Referring to FIGS. 1 and 2 collectively, in block 202, compiler 102 receives training computer program 110 and circuit design 112. In block 204, compiler 102 is capable of generating pipeline snapshot data 114. For example, compiler 102 is capable of simulating execution of training computer program 110 by the processor core as represented by circuit design 112. For each clock cycle of the simulation (e.g., a set of a plurality of clock cycles), the state of the pipeline of circuit design 112 (e.g., the processor core), as simulated, is stored as part of pipeline snapshot data 114. In general, the state of the pipeline for a given clock cycle is stored as a snapshot. Pipeline snapshot data 114 specifies the state of the pipeline of the processor core represented by circuit design 112 in executing training computer program 110 on a per-cycle basis. Each snapshot defines which, if any, instruction is located in each stage of the pipeline for a selected clock cycle. As discussed, the ordering of stages of the pipeline is known. As such, the sequence of the instructions contained in the pipeline for the selected clock cycle is also captured by a snapshot.

In one example implementation, compiler 102 is capable of generating an instruction sequence that may be specified as an LST file, from which compiler 102 generates pipeline snapshot data 114. Pipeline snapshot data 114, for example, may be specified as a matrix including a plurality of rows and a plurality of columns. Each row of the matrix may correspond to one clock cycle of execution of the simulation of training computer program 110. Each column may correspond to a particular instruction and a particular stage of the pipeline. As noted, since the pipeline has a known architecture and sequence of the stages, each snapshot (e.g., row of the matrix) of pipeline snapshot data 114 will specify a sequence of one or more instructions in the pipeline.

For purposes of illustration, consider an example where the instruction set of the processor core includes 200 possible instructions and the pipeline of the processor core is 10 sequential stages. In that case, the matrix may include 2,000 columns (e.g., 200 instructions×10 stages). For any given row of the matrix, a maximum of 10 columns will include non-zero values. In this regard, the matrix is considered sparsely populated. It should be appreciated that the matrix (e.g., pipeline snapshot data 114) need not include a snapshot of every possible state of the pipeline. Rather, pipeline snapshot data 114 need only include snapshots of the states of the pipeline reached through simulated execution of training computer program 110.

In block 206, compiler 102 is capable of generating a simulation dump 116 from simulating training computer program 110 using circuit design 112. The simulation performed by compiler 102 (e.g., a functional simulation) may also generate simulation dump 116, which specifies signal data, e.g., signal values taken or sampled on a per-clock cycle basis. Simulation dump 116 specifies signal values over time, e.g., throughout the time period corresponding to the simulation. In one example, simulation dump 116 may be specified as a Value Change Dump (VCD) file. In another aspect, simulation dump 116 may be specified as a Fast Simulation Database (FSDB) file. Both VCD and FSDB files are ASCII files that are capable of specifying signal waveform data.

The particular example file formats and/or data structures of simulation dump 116 and/or of pipeline snapshot data 114 or that are used to generate such data are provided for purposes of illustration and not limitation. It should be appreciated that other file formats may be used in lieu of and/or in addition to those described. Further, in accordance with the inventive arrangements described herein, compiler 102 may be implemented as one or more computer programs capable of performing the functions described and generating the data described. In one illustrative example, compiler 102 may be implemented as verification flow that wraps one or more sub-programs together to perform the operations described.

In block 208, power GLS 104 is capable of performing a gate-level simulation of design 112 using the time varying signal values of simulation dump 116 as input. Power GLS 104 is capable of generating pipeline power data 118. Pipeline power data 118 specifies an estimate of power consumption for the pipeline of the processor core on a per-clock cycle basis. Pipeline power data 118 does not specify power consumption estimates for components or portions of the processor core other than the pipeline. Pipeline power data 118 may include power consumption estimates for time periods where the processor core experiences a stall condition. A stall condition in the processor core is where instructions are not moving through the pipeline. A stall condition exists where the value of the program counter in pipeline snapshot data 114 does not change despite the clock cycle changing or advancing. Thus, pipeline power data 118 includes estimates of power consumption for the processor core for clock cycles in which a stall condition occurs.

In block 210, non-pipeline power analyzer 106 is capable of receiving data generated by power GLS 104, which includes data corresponding to the non-pipeline components of the processor core (e.g., circuit design 112). In one aspect, non-pipelined analyzer 106 is capable of generating non-pipeline power data 120. Non-pipeline power data 120 specifies an estimate of power consumption for the non-pipeline components or portions of the processor core on a per-clock cycle basis based on data output from power GLS 104.

For purposes of integrating non-pipeline power data 120 with pipeline power data 118 in generating IPM 124, the state of the non-pipeline components of the processor core, shown as non-pipelined state data 122, may be determined from simulation dump 116. That is, for a given clock cycle where an estimate of power consumption for the non-pipeline components is determined, state data (e.g., signal values of such circuit nodes) for the non-pipeline components may be determined from simulation dump 116. In one aspect, non-pipeline analyzer 106 is capable of generating non-pipeline state data 122.

As an illustrative example, non-pipeline analyzer 106 is capable of generating cycle-by-cycle estimates of power consumption for components of the processor core whose activities are not reflected in the state of the pipeline. Examples of these activities may include reading data from a memory and/or writing data to a memory. For example, a direct memory access (DMA) circuit or engine may be included in the processor core. Data reading and writing activities of the DMA circuit may not be reflected or captured by the state of the pipeline of the processor core. Thus, the DMA circuit is an example of a non-pipeline component. Another example of a non-pipeline component is a memory interface to a memory coupled to the processor core. Still another example of a non-pipeline component is a data mover circuit such as a memory-mapped switch or a stream switch.

Thus, non-pipeline power data 120 may specify the power consumed by non-pipeline components at a given cycle. The non-pipelined state data 122, as read from simulation dump 116, may be used to determine the particular operations performed by the non-pipeline components (e.g., reading data from memory, writing data to memory, communicating via another available data channel with another component, and/or the like).

In another aspect, the operations performed by non-pipelined analyzer 106 may be incorporated into, e.g., be part of, Power GLS 104.

In block 212, model generator 108 is capable of correlating the different types of data generated. In one or more example implementations, model generator 108 is capable of combining pipeline snapshot data 114 with non-pipeline state data 122. For example, particular states of non-pipeline components or portions of the processor core may be added as additional columns to the matrix of the snapshots of pipeline snapshot data 114. The resulting combined matrix may include both snapshots of pipeline states and the states of non-pipeline components of the processor core combined based on clock cycle.

Model generator 108 is also capable of determining an estimate of the total power consumption of the processor core per clock cycle by summing the power estimates from pipeline power data 118 with the power estimates of non-pipeline power data 120 on a per-clock cycle basis. In one aspect, the total power may be specified or stored as another matrix referred to herein for purposes of description as a power matrix. The power matrix may be specified as a single column matrix where each row corresponds to a clock cycle.

In block 214, model generator 108 is capable of generating IPM 124 using the correlated data. In one aspect, model generator 108 is capable of using a learning technique to generate IPM 124. An example of a learning technique that may be used by model generator 108 is a multi-variable linear model. In an example implementation, model generator 108 is capable of performing an iterative training technique to determine a set of weights that converge or substantially converge so that IPM 124 provides a desired input-output relationship. In this example, the combined matrix may be the input and the power matrix may be the output. The weights being developed are adjusted to provide the desired input-output relationship (e.g., convergence).

In one aspect, the learning process, as performed by model generator 108, is capable of adjusting the weights to change the input-output relationship so that an input-output accuracy cost function is optimized. In this way, the goal of a training process is to change the input-output relationship of IPM 124. Computational efficiency may not be a consideration during the training process. It should be appreciated, however, that other learning techniques beyond those described herein may be used to generate IPM 124. In one or more other example implementations, other statistical techniques and/or machine-learning techniques may be used to generate IPM 124.

Accordingly, model generator 108 is capable of performing a process that determines the values of the weights so that, for a given snapshot and non-pipeline state of the processor core, the weights may be applied to result in the total power (e.g., the sum of the pipeline power consumption and the non-pipeline power consumption) for a selected clock cycle. IPM 124 may be specified as the resulting state data and corresponding weights.

In the example of FIGS. 1 and 2, IPM 124 is generated using both pipeline and non-pipeline state (e.g., pipeline snapshot data 114 and non-pipeline state data 122) and pipeline and non-pipeline power data (e.g., the sum of pipeline power data 118 and non-pipeline power data 120). In one or more other example implementations, IPM 124 may be generated using only pipeline snapshot data 114 and pipeline power data 118.

In one or more example implementations, IPM 124 may be optimized to increase the computational efficiency of using the model. This may include reducing the size of IPM 124. Increasing the computational efficiency of the model may implemented by modifying the model (e.g., reducing the size of the model) while substantially maintaining the same input-output relationship of the original model. In other cases, the increased computational efficiency resulting from the modifications to the model may sacrifice input-output accuracy for better computational efficiency.

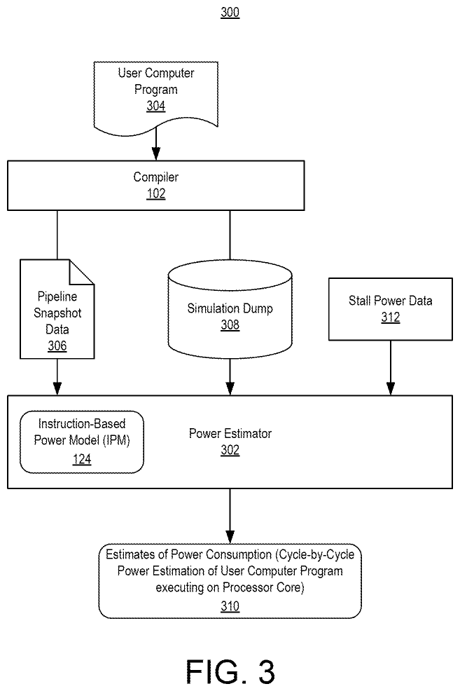

FIG. 3 illustrates an example system 300 for estimating the power consumption of a processor core in executing a selected computer program using an IPM for the processor core. System 300 may be implemented as a combination of hardware and software as embodied in a data processing system. For example, system 300 may be implemented as a computer system executing suitable program code. System 300 may be implemented in the same data processing system as system 100 or a different data processing system. An example of a data processing system in which system 300 may be implemented is described in connection with FIG. 7. System 300 illustratively includes compiler 102 and a power estimator 302.

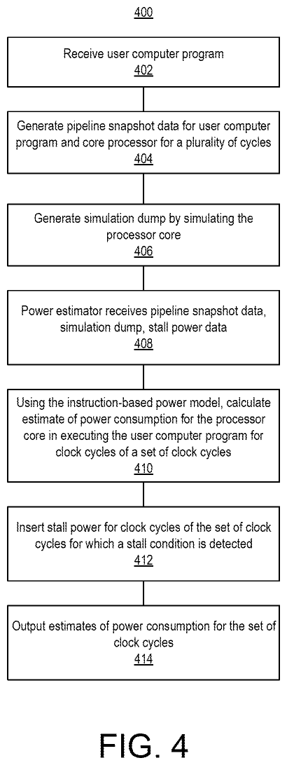

FIG. 4 illustrates an example method 400 of generating per-cycle (e.g., cycle-by-cycle) estimates of power consumption for a user computer program executing on the processor core using the IPM 124 generated as described herein. Whereas FIGS. 1-2 are directed to generation of IPM 124, FIGS. 3-4 are directed to application of IPM 124.

Referring to FIGS. 3 and 4 collectively, in block 402, compiler 102 receives a user computer program 304. User computer program 304 is the computer program for which cycle-by-cycle estimates of power consumption are to be generated were the computer program executed on the processor core. In block 404, compiler 102 is capable of generating pipeline snapshot data 306. For example, compiler 102 is capable of simulating execution of user computer program 304 to generate pipeline snapshot data 306.

In block 406, compiler 102 is capable of generating simulation dump 308 for user computer program 304. Simulation dump 308 specifies signals of the processor core determined through simulation of user computer program 304 as described in connection with FIGS. 3-4, albeit for user computer program 304. Simulation dump 308, for example, specifies the time varying signals from nodes of the processor core beyond those of the pipeline. The time varying signals of simulation dump 308 indicate the states of non-pipeline components of the processor core during the simulation. As an illustrative and non-limiting example, power estimator 302 is capable of determining, from simulation dump 308, states of the non-pipeline components of the processor core. As such, power estimator 302 is capable of determining whether the processor core is reading data from memory, writing data to memory, or performing other operations as described herein for a given cycle of the simulation based on the signal values contained in simulation dump 308.

In block 408, power estimator 302 is capable of receiving pipeline snapshot data 306, simulation dump 308, and stall power data 312. Stall power data 312 includes one or more estimates of power consumption of the processor core for clock cycles in which a power stall condition was detected during the training described in connection with FIGS. 1-2. Power estimator 302 may include IPM 124.

In block 410, for each clock cycle for which pipeline snapshot data is obtained, power estimator 302 is capable of calculating an estimate of power consumption of the processor core in executing user computer program 304 using IPM 124. As an illustrative and non-limiting example, power estimator 302 is capable of using the combination of a selected snapshot from pipeline snapshot data 306 and the state of the non-pipeline components of the processor core from simulation dump 308, both for a selected clock cycle, and determining an estimate of power consumption for the processor core for the selected clock cycle.

Power estimator 302 is capable of calculating the power consumption of the processor core for the selected clock cycle based on which instructions are located in particular stages of the pipeline and/or other state data of the processor core (e.g., whether a read operation and/or a write operation is performed). For each clock cycle, IPM 124 specifies the contribution of a particular instruction being located in a particular stage and/or the state of the processor core (performing a read and/or a write operation) toward the estimate of power consumption for the cycle. Power estimator 302 is capable of generating an estimate of power consumption for each clock cycle in the range of clock cycles corresponding to pipeline snapshot data 306 and simulation dump 308, or for another user specified set of clock cycles.

In block 412, the power estimator 302 is capable of inserting an estimate of the power consumption for a stall condition, referred to herein as stall power consumption, for any clock cycles of the specified set of clock cycles for which a stall condition was detected. In one or more example implementations, power estimator 302 is capable of detecting stall conditions by determining that the value of the program counter in pipeline snapshot data 306 has not changed despite the clock cycle changing or advancing. In response to detecting a stall condition, power estimator 302 is capable of using a stall power consumption as the estimate of power consumption for the processor core for the clock cycle in place of calculating an estimate of power consumption using IPM 124. As discussed, the estimate of stall power consumption may be determined from the gate level simulation performed during training as described in the examples of FIGS. 1 and 2.

In block 414, power estimator 302 is capable of outputting the estimates of power consumption 310 for user computer program 304 and the processor core. The estimates of power consumption are cycle-by-cycle estimate of power consumption of the processor core that account for the state of the pipeline and the state of non-pipeline components of the processor core.

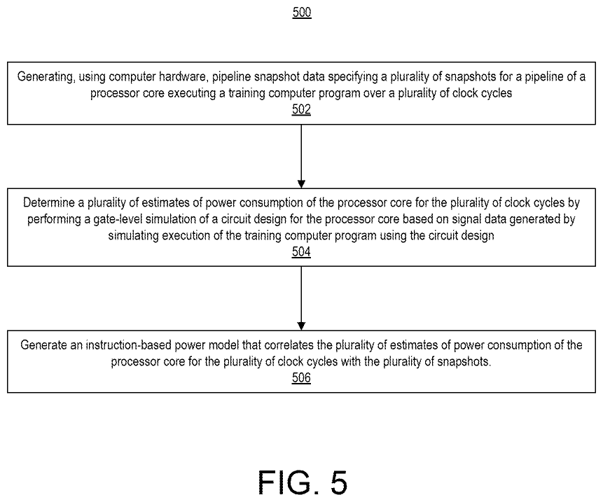

FIG. 5 illustrates another example method 500 of generating an IPM. Method 500 may be performed using system 100 of FIG. 1.

In block 502, the system is capable of generating, using computer hardware, pipeline snapshot data 114 specifying a plurality of snapshots for a pipeline of a processor core executing training computer program 110 over a plurality of clock cycles. In block 504, the system is capable of determining a plurality of estimates of power consumption of the processor core for the plurality of clock cycles (e.g., pipeline power data 118) by performing a gate-level simulation of circuit design 112 for the processor core. The gate-level simulation may be performed by power GLS 104 based on signal data, e.g., simulation dump 116, generated by simulating execution of training computer program 110 using circuit design 112. In block 506, the system is capable of generating IPM 124. IPM 124 correlates the plurality of estimates of power consumption (e.g., pipeline power data 118) of the processor core for the plurality of clock cycles with the plurality of snapshots of pipeline snapshot data 114.

The foregoing and other implementations can each optionally include one or more of the following features, alone or in combination. Some example implementations include all the following features in combination.

In one aspect, IPM 124 specifies a contribution of an instruction in a particular stage of the pipeline toward the plurality of estimates of power consumption.

In another aspect, generating IPM 124 includes training IPM 124 to determine the contributions of the instruction in a particular stage of the pipeline toward the plurality of estimates of power consumption.

In another aspect, the gate-level simulation generates non-pipeline state data 122 indicating states of non-pipeline portions of the processor core and non-pipeline power data 120. The non-pipeline state data 122 and non-pipeline power data 120 may be incorporated into IPM 124 on a per clock cycle basis. In an example implementation, non-pipeline state data 122 indicates occurrences of reads from a memory and/or writes to the memory.

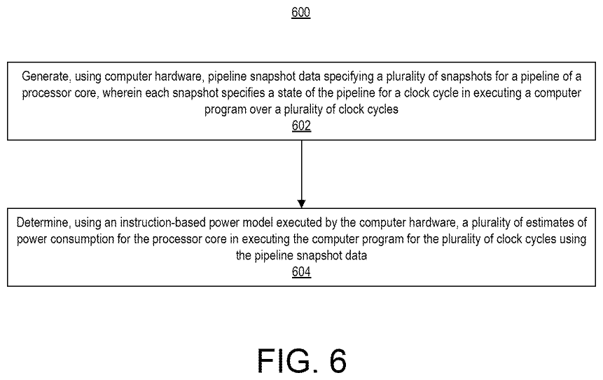

FIG. 6 illustrates another example method 600 of estimating power consumption of a processor core using an IPM. Method 600 may be performed using system 300 of FIG. 3.

In block 602, the system is capable of generating pipeline snapshot data 306. Pipeline snapshot data 306 specifies a plurality of snapshots for a pipeline of a processor core. Each snapshot specifies a state of the pipeline for a clock cycle in executing a user computer program 304 over a plurality of clock cycles.

In block 604, the system is capable of determining a plurality of estimates of power consumption 310 for the processor core in executing user computer program 304 for the plurality of clock cycles. The system is capable of calculating the plurality of estimates 310 using IPM 124 executed by computer hardware. IPM 124 uses pipeline snapshot data 306 as input. For example, the system is capable of calculating the plurality of estimates of power consumption 310 using IPM 124 based, at least in part, on the plurality of snapshots over the plurality of clock cycles.

The foregoing and other implementations can each optionally include one or more of the following features, alone or in combination. Some example implementations include all the following features in combination.

In one aspect, each estimate of the plurality of estimates of power consumption is specific to a selected clock cycle of the plurality of clock cycles and a selected snapshot corresponding to the selected clock cycle.

In another aspect, IPM 124 determines each estimate of the plurality of estimates based on contributions of instructions in particular stages of the pipeline for a selected clock cycle of the plurality of clock cycles based, at least in part, on a selected snapshot of the plurality of snapshots corresponding to the selected clock cycle.

In another aspect, the method can include determining non-pipeline state data indicating states of non-pipeline portions of the processor core. The non-pipeline state data may be used by IPM 124 in determining the plurality of estimates 310 of power consumption for the plurality of clock cycles. The non-pipeline state data is capable of indicating occurrences of reads from a memory and writes to the memory.

In another aspect, the plurality of power estimates include a power estimation component corresponding to states of the non-pipeline portions of the processor core. For example, the estimates of power consumption, determined using IPM 124, may account for both power consumption of the pipeline and power consumption of non-pipeline components of the processor core.

In another aspect, determining the plurality of estimates of power consumption 310 for the plurality of clock cycles includes using one or more estimates of stall power consumption (e.g., stall power data 312) of the processor core for selected cycles of the plurality of clock cycles for which a stall condition is detected.

In another aspect, the estimate(s) of stall power consumption are determined from a gate-level simulation (e.g., by power GLS 104) of circuit design 112 for the processor core. The gate-level simulation uses signal data (e.g., simulation dump 116) obtained from a simulation of training computer program 110.

FIG. 7 illustrates an example of a data processing system 700. The components of data processing system 700 can include, but are not limited to, a processor 702, a memory 704, and a bus 706 that couples various system components including memory 704 to processor 702. Processor 702 may be implemented as one or more processors. In an example, processor 702 is implemented as a central processing unit (CPU). Example processor types include, but are not limited to, processors having an x86 type of architecture (IA-32, IA-64, etc.), Power Architecture, ARM processors, and the like.

Bus 706 represents one or more of any of a variety of communication bus structures. By way of example, and not limitation, bus 706 may be implemented as a Peripheral Component Interconnect Express (PCIe) bus. Data processing system 700 typically includes a variety of computer system readable media. Such media may include computer-readable volatile and non-volatile media and computer-readable removable and non-removable media.

In the example of FIG. 7, data processing system 700 includes memory 704. Memory 704 can include computer-readable media in the form of volatile memory, such as random-access memory (RAM) 708 and/or cache memory 710. Data processing system 700 also can include other removable/non-removable, volatile/non-volatile computer storage media. By way of example, storage system 712 can be provided for reading from and writing to a non-removable, non-volatile magnetic and/or solid-state media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 706 by one or more data media interfaces. Memory 704 is an example of at least one computer program product.

Program/utility 714, having a set (at least one) of program modules 716, may be stored in memory 704. By way of example, program modules 716 may represent an operating system, one or more application programs, other program modules, and program data. Program modules 716 generally carry out the functions and/or methodologies of the example implementations described within this disclosure. For example, one or more of program modules 716 can implement system 100 of FIG. 1 and/or system 300 of FIG. 3 to performing the various operations described within this disclosure upon execution by data processing system 700.

Program/utility 714 is executable by processor 702. Program/utility 714 and any data items used, generated, and/or operated upon by data processing system 700 are functional data structures that impart functionality when employed by data processing system 700.

Data processing system 700 may include one or more Input/Output (I/O) interfaces 718 communicatively linked to bus 706. I/O interface(s) 718 allow data processing system 700 to communicate with one or more external devices 720 and/or communicate over one or more networks such as a local area network (LAN), a wide area network (WAN), and/or a public network (e.g., the Internet). Examples of I/O interfaces 718 may include, but are not limited to, network cards, modems, network adapters, hardware controllers, etc. Examples of external devices also may include a display 722 and/or other devices such as a keyboard and/or a pointing device that enable a user to interact with data processing system 700.

Data processing system 700 is an example implementation of a computer. Data processing system 700 can be practiced as a standalone device (e.g., as a user computing device or a server, as a bare metal server), in a cluster (e.g., two or more interconnected computers), or in a distributed cloud computing environment (e.g., as a cloud computing node) where tasks are performed by remote processing devices that are linked through a communications network. In a distributed cloud computing environment, program modules may be located in both local and remote computer system storage media including memory storage devices. The example of FIG. 7 is not intended to suggest any limitation as to the scope of use or functionality of example implementations described herein. Data processing system 700 is an example of a data processing system and/or computer hardware that is capable of performing the various operations described within this disclosure.

In this regard, data processing system 700 may include fewer components than shown or additional components not illustrated in FIG. 7 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

Data processing system 700 may be operational with numerous other general-purpose or special-purpose computing system environments or configurations. Examples of computing systems, environments, and/or configurations that may be suitable for use with data processing system 700 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

As defined herein, the singular forms “a,” “an,” and “the” are intended to include the plural forms as well, unless the context clearly indicates otherwise.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without human intervention. As defined herein, the term “user” means a human being.

As used herein, the term “cloud computing” refers to a computing model that facilitates convenient, on-demand network access to a shared pool of configurable computing resources such as networks, servers, storage, applications, ICs (e.g., programmable ICs) and/or services. These computing resources may be rapidly provisioned and released with minimal management effort or service provider interaction. Cloud computing promotes availability and may be characterized by on-demand self-service, broad network access, resource pooling, rapid elasticity, and measured service.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. The various forms of memory, as described herein, are examples of computer readable storage media. A non-exhaustive list of more specific examples of a computer readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a portable compact disc read-only memory (CD-ROM), a digital versatile disk (DVD), a memory stick, a floppy disk, or the like.

As defined within this disclosure, the term “data structure” means a physical implementation of a data model's organization of data within a physical memory. As such, a data structure is formed of specific electrical or magnetic structural elements in a memory. A data structure imposes physical organization on the data stored in the memory as used by an application program executed using a processor.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the term “responsive to” and similar language as described above, e.g., “if,” “when,” or “upon,” means responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, “data processing system” means one or more hardware systems configured to process data, each hardware system including at least one processor programmed to initiate operations and memory. Examples of data processing systems include a computer and a System-on-Chip including a processor and memory.

As defined herein, the term “processor” means at least one circuit capable of carrying out instructions contained in program code. The circuit may be an IC or embedded in an IC.

As defined herein, the term “output” means storing in physical memory elements, e.g., devices, writing to display or other peripheral output device, sending or transmitting to another system, exporting, or the like.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

A computer program product may include a computer readable storage medium (or media) having computer readable program instructions thereon for causing a processor to carry out aspects of the inventive arrangements described herein. Within this disclosure, the term “program code” is used interchangeably with the term “computer readable program instructions.” Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer readable program instructions may include state-setting data. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer readable program instructions by utilizing state information of the computer readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, e.g., program code.

These computer readable program instructions may be provided to a processor of a computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more executable instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

What is claimed is:

1. A method, comprising:
generating, using computer hardware, pipeline snapshot data specifying a plurality of snapshots for a pipeline of a processor core, wherein each snapshot specifies a state of the pipeline for a clock cycle in executing a computer program over a plurality of clock cycles; and
determining, using an instruction-based power model executed by the computer hardware, a plurality of estimates of power consumption for the processor core in executing the computer program for the plurality of clock cycles based, at least in part, on the snapshots of the pipeline snapshot data.

2. The method of claim 1, wherein each estimate of the plurality of estimates of power consumption is specific to a selected clock cycle of the plurality of clock cycles and a selected snapshot corresponding to the selected clock cycle.

3. The method of claim 1, wherein the instruction-based power model determines each estimate of the plurality of estimates based on contributions of instructions in particular stages of the pipeline for a selected clock cycle of the plurality of clock cycles based, at least in part, on a selected snapshot of the plurality of snapshots corresponding to the selected clock cycle.

4. The method of claim 1, comprising:
generating non-pipeline state data indicating states of non-pipeline portions of the processor core, wherein the non-pipeline state data is used by the instruction-based power model in the determining the plurality of estimates of power consumption for the plurality of clock cycles.

5. The method of claim 4, wherein the plurality of power estimates include a power estimation component corresponding to states of the non-pipeline portions of the processor core.

6. The method of claim 4, wherein the non-pipeline state data indicates occurrences of reads from a memory and writes to the memory.

7. The method of claim 1, wherein the determining the plurality of estimates of power consumption for the plurality of clock cycles includes using one or more estimates of stall power consumption of the processor core for selected cycles of the plurality of clock cycles for which a stall condition is detected.

8. The method of claim 7, wherein the one or more estimates of stall power consumption are determined from a gate-level power simulation of a circuit design for the processor core, the gate-level power simulation using signal data obtained from a simulation of a training computer program.

9. A system, comprising:
a processor configured to initiate operations including:
generating, using computer hardware, pipeline snapshot data specifying a plurality of snapshots for a pipeline of a processor core representing states of the pipeline in executing a computer program over a plurality of clock cycles; and
determining, using an instruction-based power model executed by the computer hardware, a plurality of estimates of power consumption for the processor core in executing the computer program for the plurality of clock cycles based, at least in part, on the snapshots of the pipeline snapshot data.

10. The system of claim 9, wherein each estimate of the plurality of estimates of power consumption is clock cycle specific.

11. The system of claim 9, wherein the processor is configured to initiate operations including:
generating non-pipeline state data indicating states of non-pipeline portions of the processor core, wherein the non-pipeline state data is used in the determining the plurality of estimates of power consumption for the plurality of clock cycles.

12. The system of claim 11, wherein the non-pipeline state data indicates occurrences of reads from a memory and writes to the memory.

13. The system of claim 9, wherein the determining the plurality of estimates of power consumption for the plurality of clock cycles includes using one or more estimates of stall power consumption of the processor core for selected cycles of the plurality of cycles for which a stall condition is detected.

14. The system of claim 13, wherein the one or more estimates of stall power consumption are determined from a gate-level power simulation of a circuit design for the processor core, the gate-level power simulation using signal data obtained from a simulation of a training computer program.

15. The system of claim 9, wherein each snapshot of the pipeline snapshot data specifies a contribution of an instruction in a particular stage of the pipeline toward the estimate of power consumption of the processor core.

16. A method, comprising:
generating, using computer hardware, pipeline snapshot data specifying a plurality of snapshots for a pipeline of a processor core executing a training computer program over a plurality of clock cycles;
determining a plurality of estimates of power consumption for the processor core for the plurality of clock cycles by performing a gate-level simulation of a circuit design for the processor core based on signal data generated by simulating execution of the training computer program using the circuit design; and
generating an instruction-based power model that correlates the plurality of estimates of power consumption of the processor core for the plurality of clock cycles with the plurality of snapshots.

17. The method of claim 16, wherein the instruction-based power model specifies a contribution of an instruction in a particular stage of the pipeline toward the plurality of estimates of power consumption.

18. The method of claim 17, wherein the generating the instruction-based power model comprises training the instruction-based power model to determine the contributions of the instruction in a particular stage of the pipeline toward the plurality of estimates of power consumption.

19. The method of claim 16, wherein:
the gate-level simulation generates non-pipeline state data indicating states of non-pipeline portions of the processor core; and
the non-pipeline state data is incorporated into the instruction-based power model on a per clock cycle basis.

20. The method of claim 19, wherein the non-pipeline state data indicates occurrences of reads from a memory and writes to the memory.
